(19) United States
(12) Patent Application Publication
(10) Pub. No.: US 2024/0016209 A1
(43) Pub. Date: Jan. 18, 2024

(54) ELECTRONIC CIGARETTE

(71) Applicant: SHENZHEN KUKI ELECTRONIC CO., LTD., Shenzhen (CN)

(72) Inventors: Rongyuan ZHU, Shenzhen (CN); Jianhua YU, Shenzhen (CN)

(21) Appl. No.: 18/097,537

(22) Filed: Jan. 17, 2023

Related U.S. Application Data
(63) Continuation of application No. PCT/CN22/21384, filed on Sep. 26, 2022.

(30) Foreign Application Priority Data
Jul. 18, 2022 (CN) 202221852677.4
Aug. 11, 2022 (CN) 202222120698.3

(51) Int. Cl. A24F 40/42; A24F 40/46; A24F 40/51; A24F 40/57

(52) U.S. Cl. CPC A24F 40/42; A24F 40/46; A24F 40/51; A24F 40/57

(57) ABSTRACT

Disclosed in the present application is an electronic cigarette, including a cigarette stem and a cartridge, in which a battery and a PCB board are provided in the cigarette stem, an atomizer configured for a atomization of e-liquid is provided in the cartridge, the atomizer includes a ceramic atomizing core, a heating wire configured for heating the e-liquid and a temperature sensing element configured for a temperature detection of the heating wire, the heating wire and the temperature sensing element are provided on the ceramic atomizing core, the heating wire is electrically connected to the battery, the temperature sensing element is electrically connected to the PCB board.

### CROSS-REFERENCE TO RELATED APPLICATIONS

The present application is a continuation of PCT application no. PCT/CN2022/121384, filed on Sep. 26, 2022, which claims the priority benefit of China application no. 202221852677.4, filed on Jul. 18, 2022, and China application no. 202222120698.3, filed on Aug. 11, 2022. The entireties of PCT application no. PCT/CN2022/121384, China application no. 202221852677.4, and China application no. 202222120698.3 are incorporated herein by reference and made a part of this specification.

### TECHNICAL FIELD

The present application relates to the technical field of alternative products of traditional cigarettes, and in particular, to an electronic cigarette.

### BACKGROUND

Electronic cigarette is also called as virtual cigarette or electronic atomizer, which is similar to a cigarette in taste, acting as a non-burning alternative product of cigarettes. The electronic cigarette generally consist of two parts, that is, a cigarette stem and a cartridge. A battery is provided in the cigarette stem. An atomizer is provided in the cartridge. The cartridge contains e-liquid, which is guided to the atomizer by the cartridge and atomized into vapour by heat from the atomizer as the atomizer is energized by the battery, thereby simulating a cigarette.

In related technical technologies, a porous ceramic atomizing core capable of guiding liquid is used for atomizing the e-liquid. A heating wire configured for heating the e-liquid is provided in the ceramic atomizing core. As the heating wire heats the e-liquid, a liquid surface tension of the e-liquid is reduced to an extent for the easiest atomization to atomizing the e-liquid.

In view of the above related technologies, there is a defect that the heating wire temperature is difficult to control in the conventional ceramic atomizing core. When the heating wire is at an excessively high heating temperature, it easily suffers from reduced service lifetime while causing a burning to a user, and, conversely, when the heating wire is at a too low temperature, there will be a poor effect of atomization.

### SUMMARY

In order to improve the defect that the heating wire temperature is difficult to control, the present application provides an electronic cigarette.

The electronic cigarette provided in the present application adopts the following technical solution:
an electronic cigarette, including a cigarette stem and a cartridge, wherein a battery and a PCB board are provided in the cigarette stem, an atomizer configured for atomizing e-liquid is provided in the cartridge, the atomizer comprises a ceramic atomizing core, a heating wire configured for heating the e-liquid and a temperature sensing element configured for detecting a temperature of the heating wire, the heating wire and the temperature sensing element are provided on the ceramic atomizing core, the heating wire is electrically connected to the battery, and the temperature sensing element is electrically connected to the PCB board.

By adopting the above technical solution, after being energized by the power, the heating wire heats the e-liquid, the temperature sensing element detects the temperature of the heating wire, the temperature sensing element can convert the temperature into an electrical signal and feed back the electrical signal to the PCB board, the PCB board controls a heating power of the heating wire, so that the calorific value of the heating wire is in a suitable threshold value for temperature control of the atomizer, which reduces a hidden danger that is scalding the user caused by a over high temperature, and a suitable temperature improves atomization effect of the e-liquid.

Optionally, the cartridge is provided with a plurality of electrical pins configured to connect to the PCB board, the plurality of electrical pins are arranged at intervals, two ends of the heating wire are separately provided with conductive contacts, the conductive contacts provided on two ends of the heating wire are fixed on the ceramic atomizing core and separately electrically connected to two of the electrical pins.

By adopting the above technical solution, the electrical pins are connected to the PCB board, the heating wire is connected to the electrical pins via the conductive contact, so that the heating temperature control of heating wire is realized for heating the e-liquid. Conducting electricity via contact is convenient for the heating wire to connect to the power, which reduces wire winding and is convenient for the installation and removal of the cartridge and the cigarette stem.

Optionally, the ceramic atomizing core is provided with a plurality of conductive pins, the conductive pins are in one-to-one correspondence to the electrical pins, and one conductive contact is connected to one electrical pin via one conductive pin.

By adopting the above technical solution, the conductive contact is connected to the electrical pin via the conductive pin, the heating temperature of the heating wire is controlled so that the e-liquid is heated and atomized. By providing the conductive pin for the connection between the electrical pin and the conductive contact, a connection stability of the conductive contact is improved, and bad contacts caused by inaccurate alignment is decreased.

Optionally, the temperature sensing element includes a sensing element body, a positive pin and a negative pin, the ceramic atomizing core is provided a holding groove configured to contain the sensing element body, the sensing element body is in insertion connection with the holding groove, and the positive pin and negative pin are separately electrically connected to two of the conductive pins.

By adopting the above technical solution, the sensing element body is in insertion connection with the holding groove, the positive pin and negative pin are separately electrically connected to two of the conductive pins so that the signal generated by the temperature detection of the heating wire is fed back to the PCB board. On the one hand, as the holding groove is provided, the ceramic atomizing core has reduced weight, and the installation stability of the temperature sensing element is improved. On the other hand, the space occupied by the temperature sensing element is reduced as the temperature sensing element is mounted in the holding groove, which reduces the volume of the electronic cigarette, and is convenient of installation and maintenance.

Optionally, the cartridge further comprises a casing, two limit tubes are provided in the casing, individual electrical pins are separately positioned in limit tubes, in which ends of the positive pin and the negative pin away from the sensing element body are separately positioned in the limit tubes and abut against and electrically connect to the electrical pins.

By adopting the above technical solution, the positive pin and the negative pin are located in the limit tubes, the limit tubes can limit the positive pin and the negative pin in their circumferential direction, so that the positive pin and the negative pin are able to be stably electrically connected to the conductive contact.

Optionally, three conductive pins are arranged side by side at regular intervals, and the holding groove is positioned in a sidewall of the ceramic atomizing core.

By adopting the above technical solution, arranging three conductive pins side by side at regular intervals enables the positive pin and the negative pin of the temperature sensing element to choose any two of the conductive pins for electrical connection, so that the length of the positive pin and the negative pin have not to be increased; and the temperature sensing element mounted on the sidewall of the holding groove moves away from the conductive pin in a disassembly process, so as to decrease the friction between the positive pin and negative pin of the temperature sensing element and the conductive pin.

Optionally, the holding groove and the conductive pins are positioned in a same end face, and the three conductive pins are staggered with each other at regular intervals.

By adopting the above technical solution, as the conductive pins are staggered with each other, a position on the end face is reserved for the holding groove, which provides a foundation for providing a holding groove, and the temperature sensing element is simultaneously reserved, so that the positive pin and the negative pin of the temperature sensing element are easy to be electrically connected to the conductive pin, which increases a position selectivity of the temperature sensing element.

Optionally, four conductive pins are arranged side by side at regular intervals, the holding groove is positioned in a sidewall of the ceramic atomizing core, and the positive pin and the negative pin are separately electrically connected to two middle conductive pins.

By adopting the above technical solution, arranging the four conductive pins side by side at regular intervals enables the positive pin and the negative pin of the temperature sensing element to choose any two of the conductive pins for electrical connection, which increases a position selectivity of the temperature sensing element, and enables an installation position adjustment of the temperature sensing element according to an inner assembly of the electronic cigarette.

Optionally, the holding groove and the conductive pins are positioned in a same end face, four conductive pins are staggered with each other at regular intervals, and the positive pin and the negative pin are separately electrically connected to two middle conductive pins.

By adopting the above technical solution, as the conductive pins are staggered with each other, a position on the end face is reserved for the holding groove, and the temperature sensing element is reserved, so that it is easy for a electrical connection between two of the positive pin and negative pin of temperature sensing element and the conductive pin.

Optionally, the ceramic atomizing core is further provided with two connection contacts configured for electrical connection with the temperature sensing element, the connection contacts are arranged side by side at regular intervals and fixed on the ceramic atomizing core; and the positive pin and the negative pin are connected with two connection contacts, respectively.

By adopting the above technical solution, when being energized, a current can flow from one end of the heating wire to the other end of the heating wire via the conductive contact, so that the heating wire can generate heat. The current simultaneously flows through the connection contact, which flows from the positive pin of the temperature sensing element to the negative pin of the temperature sensing element to form a complete path, so as to realize the effect that the temperature sensing element can detect the temperature of the heating wire.

Optionally, the holding groove is positioned in a sidewall of the ceramic atomizing core, and the conductive contact and the connection contact are positioned in the same plane of the ceramic atomizing core.

By adopting the above technical solution, the temperature sensing element is mounted on the sidewall, which reduces a whole height of the atomizer. On the one hand, it makes the overall structure of the electronic cigarette more compact; and on the other hand, a longer heating wire can be contained to improve the atomization effect of the e-liquid.

Optionally, the holding groove and the conductive contact are positioned in a same plane of the ceramic atomizing core as one where the connection contact is located.

By adopting the above technical solution, when welding the temperature sensing element and the connection contact, keeping the temperature sensing element and the connection contact in the same plane is convenient for a welding operation, and reduces the length of the positive pin and the negative pin, which saves materials.

Optionally, the heating wire is provided with a heating bar, the ceramic atomizing core is provided with a first edge and a second edge, the first edge and the second edge are perpendicular to each other, and the heating bar includes at least one first bent section facing towards the first edge.

By adopting the above technical solution, the first bent section enables a length reduction of the heating wire along the direction towards the first edge, which reduces the heat accumulation on the edge of the ceramic atomizing core, so that the heat on the edge of the ceramic atomizing core is reduced.

Optionally, the heating bar comprises at least one second bent section facing towards or being parallel to the second edge.

By adopting the above technical solution, the second bent section enables a length increase of the heating wire along the direction towards the second edge, meanwhile, as coordinated with the first bent section, the overall length of the heating wire is increased, which effectively increases a heating area, and improves the heating uniformity of the e-liquid.

Optionally, the atomizer further comprises a spring clip configured for fixing the temperature sensing element, the ceramic atomizing core is provided with a clamping part, wherein the spring clip clamps the clamping part, the temperature sensing element is sandwiched between the ceramic atomizing core and the spring clip, and the temperature sensing element is mounted on the spring clip and electrically connected to a power supply.

By adopting the above technical solution, the temperature sensing element is firstly mounted on the spring clip in a installation process, and the temperature sensing element is sandwiched between the ceramic atomizing core and the spring clip to detect the temperature of the heating wire. When the temperature sensing element is needed to be replaced, the temperature sensing element can be removed from the ceramic atomizing core as the spring clip is dismantled, which is convenient for the overhaul and replacement of the temperature sensing element on the one hand, and reduces damage of the ceramic atomizing core on the other hand.

In summary, the present application has at least one of the following beneficial technical effects:

A temperature of the heating wire can be detected. After being energized, the heating wire heats the e-liquid, the temperature sensing element detects the temperature of the heating wire, the temperature sensing element can convert the temperature into a electrical signal and feed back the electrical signal to the PCB board, the PCB board controls a heating power of the heating wire, so that a temperature of the ceramic atomizing core is in a suitable threshold value for precise temperature control, which reduces a hidden danger of burning a user due to an excessively high temperature, and a suitable temperature improves atomization effect of the e-liquid.

There are a variety of installation ways. The temperature sensing element can be mounted on the ceramic atomizing core via the spring clip, or the holding groove can be provided to contain sensing element body, so that the temperature of the heating wire can be detected by the temperature sensing element. On the one hand, the installation stability and the applicability of the temperature sensing element are improved; and on the other hand, it is convenient for the maintenance and replacement of the temperature sensing element, and the damage of the ceramic atomizing core is reduced.

The heat accumulation is reduced. The first bent section enables a length reduction of the heating wire along the direction towards the first edge, which reduces the heat accumulation on the edge of the ceramic atomizing core, so that the heat on the edge of the ceramic atomizing core is reduced.

The e-liquid is heated uniformly. The second bent section enables a length increase of the heating wire along the direction towards the second edge, meanwhile, as coordinated with the first bent section, the overall length is increased, which effectively increases a heating area, and improves the heating uniformity of the e-liquid.

### BRIEF DESCRIPTION OF THE DRAWINGS

FIG. 1 is a structure diagram of Embodiment 1 in the present application.

FIG. 2 is a structure diagram illustrating an electrical terminal of Embodiment 1 in the present application.

FIG. 3 is a structure diagram illustrating a cartridge of Embodiment 1 in the present application.

FIG. 4 is a partial schematic diagram illustrating an electrical pin of Embodiment 1 in the present application.

FIG. 5 is a structure diagram illustrating an atomizer of Embodiment 1 in the present application.

FIG. 6 is a structure diagram illustrating an atomizer of Embodiment 2 in the present application.

FIG. 7 is a structure diagram illustrating an atomizer of Embodiment 3 in the present application.

FIG. 8 is a structure diagram illustrating an atomizer of Embodiment 4 in the present application.

FIG. 9 is a structure diagram illustrating an atomizer of Embodiment 5 in the present application.

FIG. 10 is a structure diagram illustrating an atomizer of Embodiment 6 in the present application.

FIG. 11 is structure diagram illustrating an atomizer of Embodiment 7 in the present application.

FIG. 12 is a structure diagram illustrating an atomizer of Embodiment 8 in the present application.

FIG. 13 is a structure diagram illustrating an atomizer of Embodiment 9 in the present application.

FIG. 14 is a structure diagram illustrating an atomizer of Embodiment 10 in the present application.

FIG. 15 is a structure diagram illustrating an atomizer of Embodiment 11 in the present application.

FIG. 16 is a structure diagram illustrating an atomizer of Embodiment 12 in the present application.

FIG. 17 is a structure diagram illustrating an atomizer of Embodiment 13 in the present application.

FIG. 18 is a structure diagram illustrating an atomizer of Embodiment 14 in the present application.

FIG. 19 is a structure diagram illustrating an atomizer of Embodiment 15 in the present application.

FIG. 20 is a structure diagram illustrating an atomizer of Embodiment 16 in the present application.

FIG. 21 is a structure diagram illustrating an atomizer of Embodiment 17 in the present application.

FIG. 22 is a structure diagram illustrating an atomizer of Embodiment 17 in the present application.

### DESCRIPTION OF THE EMBODIMENTS

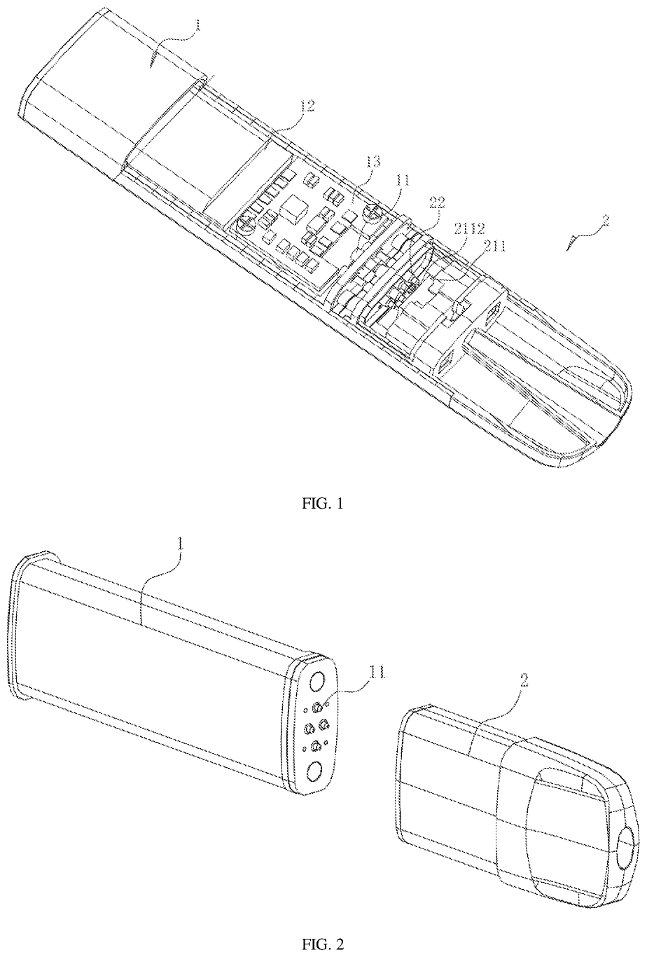

The present application will be further described in details in combination with FIGS. 1-22.

The present application provides an electronic cigarette.

### Embodiment 1

Referring to FIG. 1 and FIG. 2, an electronic cigarette includes a cigarette stem 1 and a cartridge 2, a battery 12 and a PCB board 13 are provided in cigarette stem 1, and the battery 12 is electrically connected to PCB board 13. The cartridge 2 includes a casing 23 and an atomizer 21 configured for atomizing an e-liquid. The atomizer 21 is electrically connected to the PCB board 13 so as to control the atomization effect of the e-liquid. The PCB board 13 is configured to control on/off of a heating wire 212. The casing 23 is provided outside the atomizer 21 and configured for fixing and protecting the atomizer 21. In this embodiment, the cigarette stem 1 is in snap connection with the cartridge 2 so that the cigarette stem 1 and the cartridge 2 fixed relative to each other.

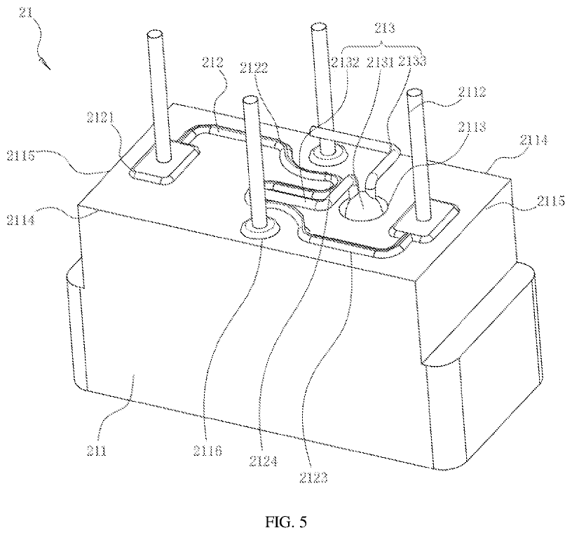

Referring to FIG. 1 and FIG. 5, the atomizer includes a ceramic atomizing core 211, a heating wire 212 and a temperature sensing element 213, and the heating wire 212 is electrically connected to the battery 12. The temperature sensing element 213 is electrically connected to the PCB board 13. The heating wire 212 is located at an upper end face of the ceramic atomizing core 211. The temperature sensing element 213 configured to detect a temperature of the heating wire 212 is mounted on the ceramic atomizing core 211. Particularly, the temperature sensing element 213 is a temperature sensor. An input terminal of the temperature sensing element 213 can be connected to the ceramic atomizing core 211 or the heating wire 212 to detect a temperature of the heating wire. After being energized, the heating wire 212 heats the e-liquid, and the temperature sensing element 213 detects the temperature of the heating wire 212. The temperature sensing element 213 can convert the temperature into an electrical signal, so that the electrical signal is fed back to the PCB board 13. The PCB board 13 controls a heating power of the heating wire 212, so that the temperature of the heating wire 212 is at a suitable threshold value, so as to precisely control the temperature of the atomizer 21.

An end face of the ceramic atomizing core 211 away from the heating wire 212 is defined with a receiving groove, in which elements of the electronic cigarette can be mounted to decrease a volume of temperature sensing heating elements, so that the volume and the weight of the electronic cigarette can be decreased.

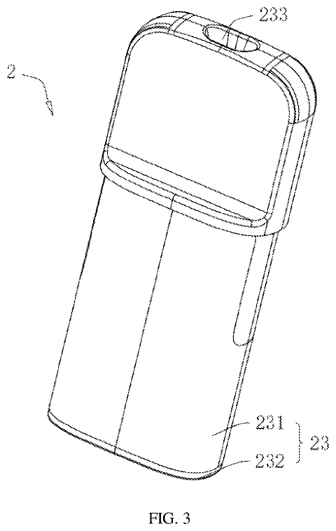

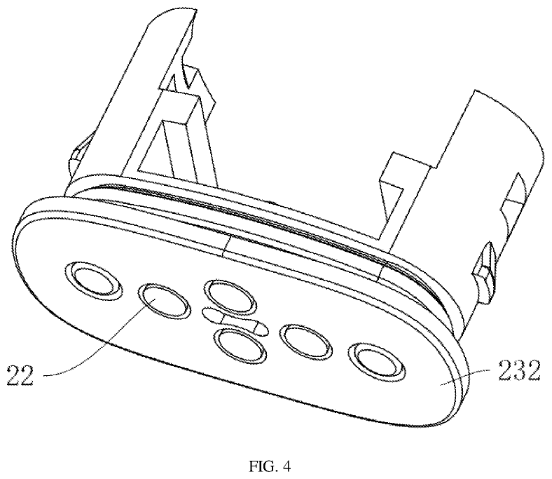

Referring FIG. 3, the casing 23 includes a casing body 231 and a bottom cover 232, the casing body 231 is provided with a mounting chamber, and the bottom cover 232 is in snap connection with the casing body 231, and is configured to cover the mounting chamber. An end of the casing body 231 away from the bottom cover 232 is provided with a cigarette outlet 233, through which a user can smoke the electronic cigarette. The atomizer 21 is located in the mounting chamber, and the casing covers around the atomizer 21.

Referring FIG. 4 and FIG. 5, the cartridge 2 is provided with a plurality of electrical pins 22 configured to communicate the PCB board 13, arranged at intervals and extending through the bottom cover 232. The ceramic atomizing core 211 is provided with a plurality of conductive pins 2112 in one-to-one correspondence to the electrical pins 22. In this embodiment, there are four electrical pins 22 and four conductive pins 2112 provided respectively, in which four conductive pins 2112 are staggered with each other at regular intervals. The conductive pins 2112 at a head end and a tail end are located at a central axis of the ceramic atomizing core 211 along a width direction. Middle conductive pins 2112 are located at both sides of the central axis of the ceramic atomizing core 211 along the width direction.

Referring to FIG. 2 and FIG. 4, to improve a connection stability between the electrical pin 22 and the PCB board 13, an end face of the cigarette stem 1 touching the cartridge 2 is provided with an electrical terminal 11 electrically connected to the PCB board 13. The electrical terminal 11 is in elastic contact with the cigarette stem 1, which means the electrical terminal 11 can be extended or retracted relative to the cigarette stem 1. When the cigarette stem 1 is in snap connection with the cartridge 2, the electrical terminal 11 contacts the electrical pin 22, and is moved relative to the cigarette stem 1 to abut against the electrical pin 22, providing a more stable connection therebetween. There is a plurality of electrical terminals 11. The electrical terminals 11 have a same number as that of the electrical pins 22 and are in one-to-one correspondence to the latter. In this embodiment, there are four electrical terminals 11.

Referring to FIG. 5, the temperature sensing element 213 includes a sensing element body 2131, a positive pin 2132 and a negative pin 2133, in which the positive pin 2132 and negative pin 2133 are separately welded to two of the conductive pins 2112. In this embodiment, the positive pin 2132 is welded to a second conductive pin 2112, and the negative pin 2133 is welded to a third conductive pin 2112. The conductive pin 2112 contacts the electrical pin 22 so as to connect to the PCB board 13, so that the heating wire 212 is energized and heats the e-liquid. The temperature sensing element 213 detects the temperature of the heating wire 212, and in turn converts the temperature into an electrical signal and feeds the temperature electrical signal back to the PCB board 13, which controls a heating power of the heating wire 212, so that the temperature of the heating wire 212 is at a suitable value.

The ceramic atomizing core 211 is defined with a holding groove 2113 configured to contain the temperature sensing element 213, and the sensing element body 2131 is inserted in the holding groove 2113 and detachably connected with the ceramic atomizing core 211. Mounting the sensing element body 2131 of the temperature sensing element 213 in the holding groove 2113 can reduce a space occupied by the temperature sensing element 213, decrease the volume of the electronic cigarette, and facilitate installation and maintenance. Providing the holding groove 2113 help reduce a weight of the ceramic atomizing core 211 itself, while improving installation stability of the temperature sensing element 213. In this embodiment, there is one holding groove 2113, which has an opening facing toward an upper end face of the ceramic atomizing core 211, so that the positive and the negative pins 2133 of the temperature sensing element 213 can be conveniently welded to the conductive pin 2112.

The ceramic atomizing core 211 has a “ [symbol] ” shaped cross section. In particular, the ceramic atomizing core 211 has a group of parallel long edges and a group of parallel short edges. It has a first edge 2114 and a second edge 2115, and the first edge 2114 is perpendicular to the second edge 2115. In this embodiment, the first edge 2114 is the long edge, and the second edge 2115 is the short edge.

Two ends of the heating wire 212 are separately provided with conductive contacts 2121 configured to connect to a power supply. Two conductive contacts 2121 are fixed on the ceramic atomizing core 211 along a direction of the first edge 2114 and in electrical connection with two of the conductive pins 2112. In this embodiment, the conductive contact 2121 is of a flat cuboid shape. A heating bar 2122 that can generate heat upon being energized is provided between the conductive contacts 2121, assuming a long strip shape. The heating bar 2122 includes two first bent sections 2123 that are parallel to the first edge 2114 and two second bent sections 2124 that face toward the second edge 2115. In this embodiment, two second bent sections 2124 are of circular arc shape. The first bent section 2123 enables a length reduction of the heating wire 212 along the direction towards the first edge 2114, which reduces the heat accumulation on the edge of the ceramic atomizing core 211, so that the heat on the edge of the ceramic atomizing core 211 is reduced, while avoiding the conductive pin 2112. The second bent section 2124 avoids the holding groove 2113 on the one hand, and enables a length increase of the heating wire 212 along the direction towards the second edge 2115 on the other hand, It cooperates with the first bent section 2123 to increase an overall length of the heating wire 212, so as to effectively increase a heating area and improve the heating uniformity of the e-liquid.

### Embodiment 2

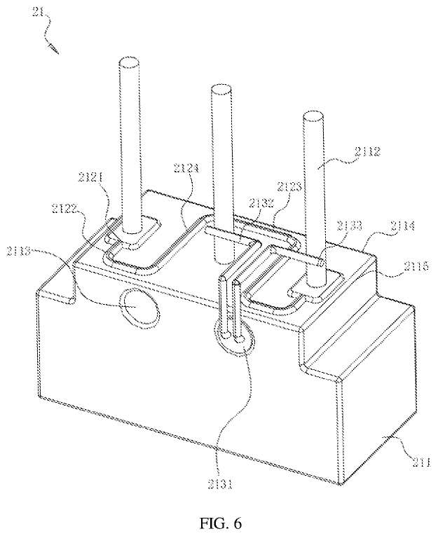

Referring to FIG. 6, the difference between the this embodiment and the embodiment is that, there are three conductive pins 2112 arranged side by side along the direction of the first edge 2114 at regular intervals, and the two ends of the heating wire 212 are separately electrically connected to the conductive pins 2112 at a head end and a tail end. To avoid the middle conductive pins 2112, the heating wire 212 is arranged in a half circle around the middle conductive pins 2112. The heating bar 2122 includes three first bent sections 2123 that are parallel to the first edge 2114 and two second bent sections 2124 that are parallel to the second edge 2115, which increases the length of the heating wire 212, and in turn a contact area between the heating wire 212 and the e-liquid, so that the e-liquid is heated more uniformly. Therefore, in the same heating time, the heating wire 212 can generate more heat, providing a better effect of atomization.

In this embodiment, there are two holding grooves, which have an opening located in a same side wall of the ceramic atomizing core 211, and are located in a same horizontal plane at vertical height. This increases installation applicability of temperature sensing element 213, so that the location of the temperature sensing element 213 can be adjusted according to the installation location of other elements in the electronic cigarette, without affecting the temperature detection function and effect of the heating wire 212.

### Embodiment 3

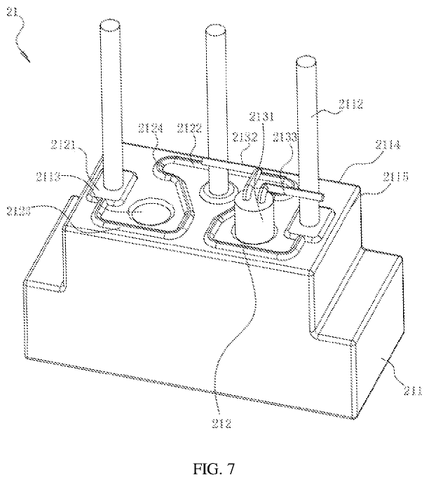

Referring to FIG. 7, the difference between this embodiment and the Embodiment 2 is that, there are two holding grooves 2113, which have an opening located in the upper end face of the ceramic atomizing core 211, and are arranged side by side along the direction of the first edge 2114 at regular intervals.

Further, the heating bar 2122 includes two first bent sections 2123 that are parallel to the first edge 2114 and four second bent sections 2124 that face toward the second edge 2115. In this embodiment, two of the second bent sections are of circular arc shape, the other two of the second bent sections 2124 are of bent shape. The second bent section 2124 avoids the middle conductive pin 2112 and the holding groove 2113.

### Embodiment 4

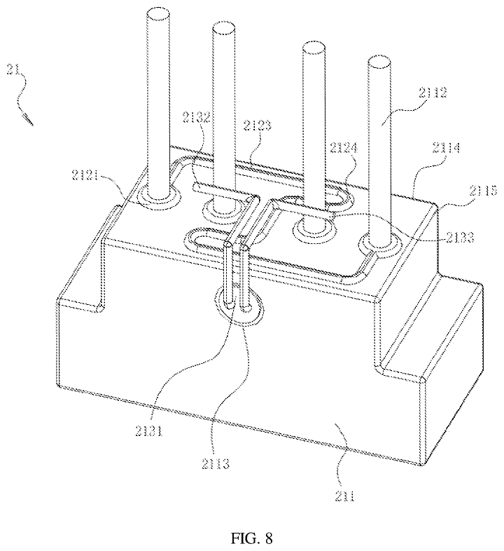

Referring to FIG. 8, the difference between this embodiment and Embodiment 1 is that, there are four conductive pins 2112 arranged side by side at regular intervals. In this embodiment, a plane where the four conductive pins are located is coplanar with a plane where the central axis along the width direction of the ceramic atomizing core 211 is located. The positive pin 2132 and the negative pin 2133 of the temperature sensing element 213 are separately welded with two middle conductive pins 2112.

There is one holding groove 2113, which has an opening located in a sidewall of the ceramic atomizing core 211. The holding groove 2113 is located in the middle of the two middle conductive pins 2112. The sensing element body 2131 is located in the holding groove and in insertion connection with the holding groove 2113.

Further, the heating bar 2122 includes two first bent sections 2123 that are parallel to the first edge 2114 and two second bent sections 2124 that face toward the second edge 2115. In this embodiment, two second bent sections are of circular arc shape.

### Embodiment 5

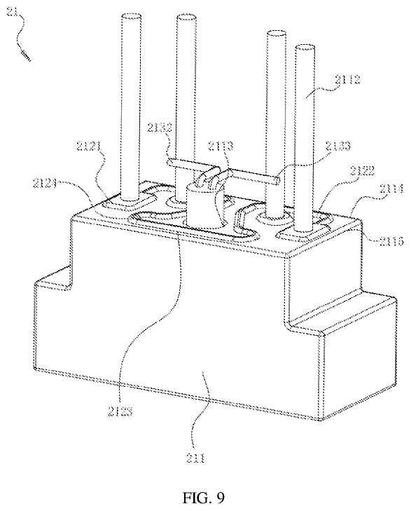

Referring to FIG. 9, the difference between this embodiment and Embodiment 4 is that, the holding groove 2113 and the conductive pin 2112 are located in the same end face, and four conductive pins 2112 are staggered with each other at regular intervals. In this embodiment, the conductive pins 2112 at a head end and a tail end are located in the central axis of the ceramic atomizing core 211 that is parallel to the first edge 2114, and two middle conductive pins 2112 are located in a side of the central axis of the ceramic atomizing core 211 that is parallel to the first edge 2114. The positive pin 2132 and the negative pin 2133 are separately welded to two middle conductive pins 2112. The holding groove 2113 is located in the other side of the central axis along the width direction of the ceramic atomizing core 211. A space for the holding groove 2113 is revered between two conductive pins 2112 located in the middle on the end face of the ceramic atomizing core 211, and both the two conductive pins 2112 avoid the sensing element body 2131.

Further, the heating bar 2122 includes three first bent sections 2123 that are parallel to the first edge 2114 and four second bent sections 2124 that face toward the second edge 2115. In this embodiment, two of the second bent sections 2124 are of circular arc shape, and the other two of the second bent sections 2124 are of bent shape.

### Embodiment 6

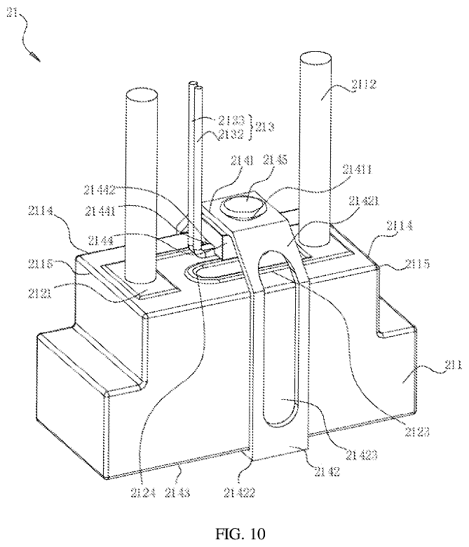

Referring to FIG. 10, the difference between this embodiment and Embodiment 1 is that, there are two conductive pins, which are configured to connect to the heating wire 212 to realize energization and heating of the heating wire 212. The heating bar 2122 includes two bent sections 2123 that are parallel to the first edge 2114 and two second bent sections 2124 that face toward the second edge 2115. In this embodiment, two second bent sections are of circular arc shape.

A atomizing core further includes a spring clip 214 configured to fix the ceramic atomizing core 211 and the temperature sensing element 213. The spring clip 214 is mounted on the upper end face of the ceramic atomizing core 211, the temperature sensing element 213 is mounted on the spring clip 214 and located between the ceramic atomizing core 211 and the spring clip 214. The conductive pin 2112 contacts the electrical pin 22 to connect to the PCB board 13. The heating wire 212 heats the e-liquid, and the temperature sensing element 213 mounted on the spring clip 214 detect the surface temperature of the ceramic atomizing core 211, and in turn convert the temperature into an electrical signal and feed a sensing signal back to the PCB board 13. In this embodiment, the temperature sensing element 213 is located at an upper end face of the ceramic atomizing core 211, and the temperature sensing element 213 is located at a center of the ceramic atomizing core 211.

The spring clip 214 is provided with a mounting part 2141 and a snap-in part 2142, the mounting part 2141 is fixed on the temperature sensing element 213, and the snap-in part 2142 is detachably connected with the ceramic atomizing core 211. The mounting part 2141 is parallel to an upper end face of the ceramic atomizing core 211, a length of the mounting part 2141 is smaller than a length of the ceramic atomizing core 211, and a width of the mounting part 2141 is smaller than a width of the ceramic atomizing core 211.

An end of the snap-in part 2142 connected to the mounting part 2141 is a connecting end 21421, an end of the snap-in part 2142 detachably connected to the ceramic atomizing core 211 is a snap connection end 21422, in which the connecting end 21421 is gradually inclined towards a central axis of the ceramic atomizing core 211 and fixed on the snap-in part 2142. The connecting end 21421 increases an angle between the snap-in part 2142 and the mounting part 2141, so that in a disassembling process of the spring clip 214, a deformation angle between the snap-in part 2142 and the mounting part 2141 increases, a movement distance of an end of the snap-in part 2142 away from the mounting part 2141 becomes longer, so that the spring clip 214 is convenient to be removed and installed, and a fracture is not easy to occurs in a joint between the snap-in part 2142 and the mounting part 2141.

The ceramic atomizing core 211 is provided with a clamping part 2143. In this embodiment, the clamping part 2143 is an end of the ceramic atomizing core 211 away from the temperature sensing element 213, an end face of the snap connection end 21422 facing towards the ceramic atomizing core 211 contacts the end face of the ceramic atomizing core 211 away from the temperature sensing element 213 to realize a snap connection, which reduces the footprint of the spring clip 214 on the ceramic atomizing core 211 along a width direction, and makes a thickness of the temperature sensing heating unit more thinner.

In this embodiment, two snap-in parts 2142 are provided and separately located in two ends of the mounting part 2141 along a width direction, the mounting part 2141 and the snap-in part 2142 are integrally formed with each other, and the spring clip 214 is made from deformable polymer material or metal materials.

Further, for the convenience of removal and installation of the spring clip 214, the snap-in part 2142 is provided with a through-hole 21423, which, on one hand, reduces the material used to produce the spring clip 214 and saves material cost, and, on the other hand, can cause an easier deformation when a same force is applied to the snap-in part 2142, which can save more effort in removal and installation process of the spring clip 214.

To improve an installation stability of the temperature sensing element 213, the spring clip 214 is provided with a silica gel support 2144 configured to support and fix the temperature sensing element 213 and a fixing pole 2145 configured for reinforcing the spring clip 214 and the silica gel support 2144.

The silica gel support 2144 is provided with a mounting groove 21441 configured to contain temperature sensing element 213 and a mounting notch 21442 configured to bend the positive pin 2132 and the negative pin 2133. In this embodiment, the sensing element body 2131 is located in the mounting groove 21441 and in interference fit with the mounting groove 21441, and the positive pin 2132 and the negative pin 2133 pass through the mounting notch 21442 and electrically connect to a battery 12. A bottom end face of the sensing element abuts against the heating wire 212. The silica support 2144 increases a contact area between the temperature sensing element 213 and the spring clip 214, so that the installation stability of the temperature sensing element 213 is improved, and meanwhile the damage of the temperature sensing element 213 is reduced as the temperature sensing element 213 is in indirect contact with the spring clip 214.

The fixing pole 2145 is provided with an abutting part 21451, the mounting part 2141 of the spring clip 214 is provided with a reserved hole 21411, the fixing pole 2145 passes through a the reserved hole 21411 and is fixed with the silica support 2144, and the abutting part 21451 contacts and presses the spring clip 214. The abutting part 21451 locks the mounting part 2141 to the silica support 2144, which enhances the installation stability between the spring clip 214 and the silica support 2144, and reduces possibility of silica support 2144 falling off caused by a temperature change, so that the installation stability of the temperature sensing element 213 is further enhanced.

### Embodiment 7

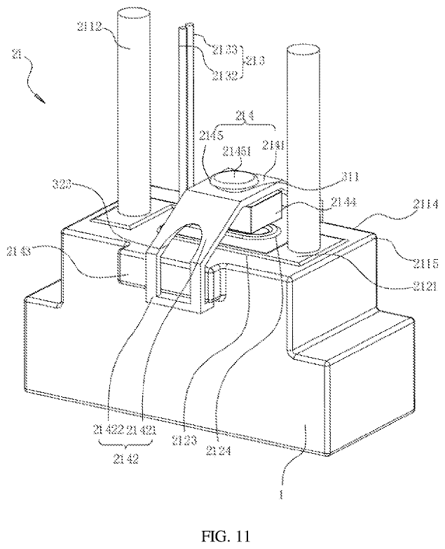

Referring FIG. 11, the difference between this embodiment and Embodiment 6 is that, the clamping part 2143 is a boss located at an end of the ceramic atomizing core 211 near the temperature sensing element 213, and the snap-in part 2142 is in snap connection with the boss. In this embodiment, two bosses are provided, and are separately symmetrically located in two sides of the central axis, positioned on an outer wall of the ceramic atomizing core 211 along a length direction. Providing the bosses increases a width of the ceramic atomizing core 211, which, on the one hand, enlarges an included angle between the snap connection end 21422 and the connecting end 21421 in a snap connection process between the snap-in part 2142 and the boss, and stabilizes the installation between the snap-in part 2142 and the boss under a rebound force of spring clip 214; and, on the other hand, reduces a distance between the snap-in part 2142 and the boss, so as to reduce scratching of a surface of the ceramic atomizing core 211 by the snap-in part 2142 during removal and installation of the spring clip 214.

### Embodiment 8

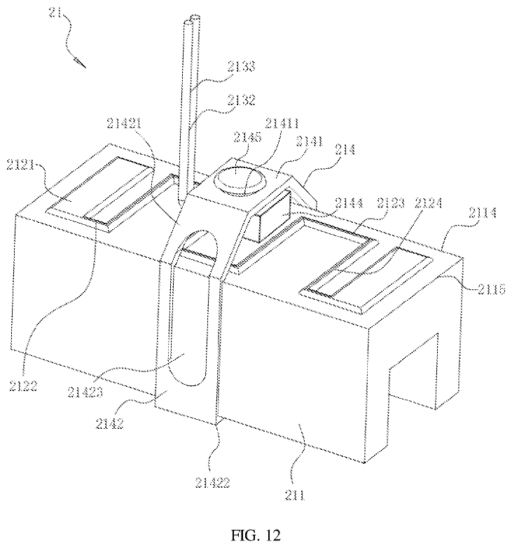

Referring to FIG. 12, the difference between this embodiment and Embodiment 7 is that, the ceramic atomizing core 2111 is of a cuboid shape. There is no conductive pin 2112 provided on upper end face of the ceramic atomizing core 2111. The conductive contact 2121 contacts the conductive pin 22, so as to connect to the PCB board 13, and control the heating temperature of the heating wire. The heating bar 2122 includes three first bent sections 2123 parallel to the first edge 2114 and four second bent sections 2124 parallel to the second edge 2115.

### Embodiment 9

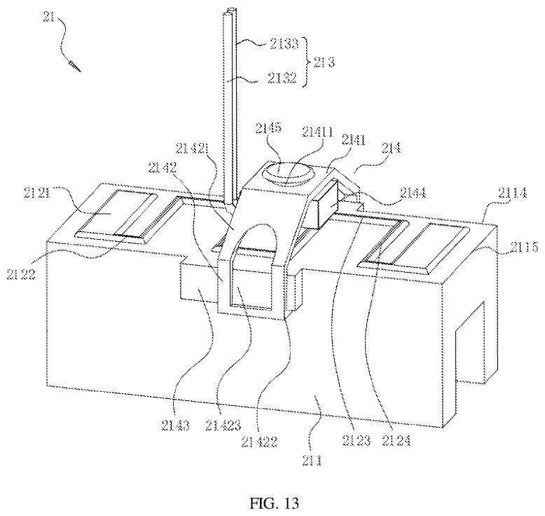

Referring to FIG. 13, the difference between this embodiment and Embodiment 8 is that, the ceramic atomizing core 2111 is of a cuboid shape, and there is no conductive pin 2112 provided on upper end face of the ceramic atomizing core 2111. The conductive contact 2121 contacts the conductive pin 22, so as to connect to the PCB board 13, and control the heating temperature of the heating wire. The heating bar 2122 includes two first bent sections 2123 parallel to the first edge 2114 and four second bent sections 2124 parallel to the second edge 2115.

### Embodiment 10

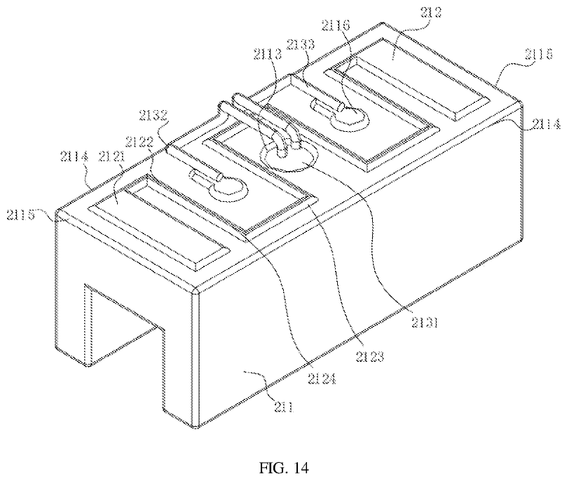

Referring to FIG. 14, the difference between this embodiment and Embodiment 2 is that, there is no conductive pin 2112 provided on ceramic atomizing core 211, and the conductive contact 2121 contacts the electrical pin 22 so as to connect to the PCB board 13. The ceramic atomizing core 211 is further provided with connection contacts 2116 configured to electrically connected to temperature sensing element 213, in which the connection contacts 2116 are arranged at intervals and fixed on the ceramic atomizing core 211. Two connection contacts 2116 are provided. The positive pin 2132 and the negative pin 2133 of the temperature sensing element 213 are arranged and welded with two connection contacts 2116 in one-to-one correspondence. In this embodiment, the connection contacts 2116 are located at a central axis of the ceramic atomizing core 211 parallel to the first edge 2114.

When being energized, a current can flow from one end of the heating wire 212 to the other end of the heating wire 212 via the conductive contact 2121, so that the heating wire 212 can generate heat. The current simultaneously flows through the connection contact 2121, which flows from the positive pin 2132 of the temperature sensing element 213 to the negative pin 2133 of the temperature sensing element 213 to form a complete path, so as to realize the effect that the temperature sensing element 213 can detect the temperature of the heating wire 212.

In this embodiment, the ceramic atomizing core 211 is in cuboid shape. One holding groove 2113 is provided, the opening of the holding groove 2113 is located in the upper end face of the ceramic atomizing core 211, the holding groove 2113, the conductive contact 2121 and the connection contact 2116 are located in the upper end face of the ceramic atomizing core 211, the connection contact 2116 is located between the conductive contacts, and the holding groove 2113 is located between two connection contacts 2116 and located in the mid-pot on the upper end face of the ceramic atomizing core 211. When welding the temperature sensing element 213 and the connection contact 2116, that the temperature sensing element 213 and the connection contact 2116 are in the same plane is convenient for a welding operation.

The heating bar 2122 includes three first bent sections 2123 towards to the first edge 2114 and four second bent sections 2124 parallel to the second edge 2115. In this embodiment, the second bent section 2124 is a straight line.

### Embodiment 11

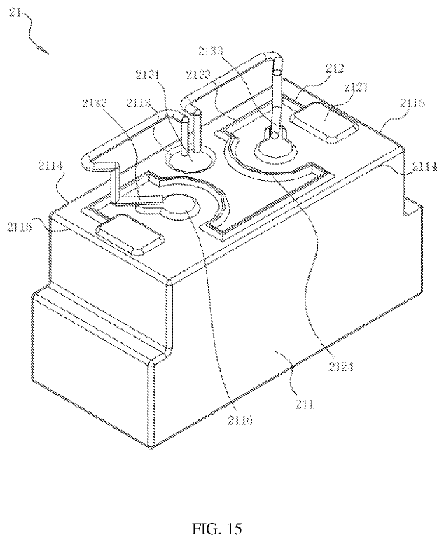

Referring to FIG. 15, the difference between this embodiment and Embodiment 10 is that, the opening of the holding groove 2113 is located on the side wall of the ceramic atomizing core 211, the conductive contact 2121 and the connection contact 2166 are located on the upper end face of the ceramic atomizing core 211, and the temperature sensing element 213 is mounted on the side wall, which reduces a whole height of the temperature sensing heating unit, and makes the overall structure of the electronic cigarette more compact.

### Embodiment 12

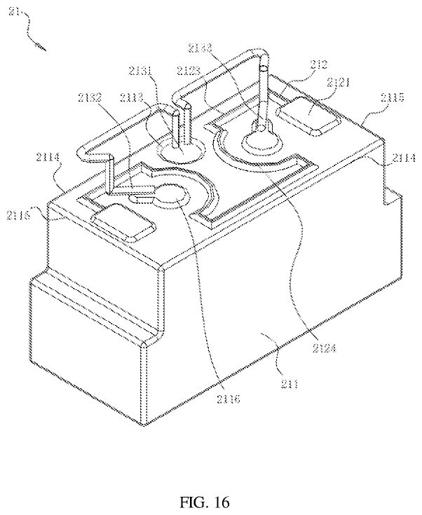

Referring to FIG. 16, the difference between this embodiment and Embodiment 11 is that, the cross section of the ceramic atomizing core 211 is of “8” shape, the holding groove 2113 is located in the mid-pot of two connection contact 2116 and a side of the central axis of the ceramic atomizing core 211 parallel to the second edge 2115. The heating bar 2122 includes three first bent sections 2123 towards to the first edge 2114 and two second bent sections 2124 towards to the second edge 2115. In this embodiment, the second bent section 2124 is in circular arc shape. The second bent section 2124 enables a length increase of the heating wire 212 along the direction towards the second edge 2115 on the other hand, meanwhile, as coordinated with the first bent section 2123, the overall length of the heating wire 212 is increased, which effectively increases a heating area, and improves the heating uniformity of the e-liquid.

### Embodiment 13

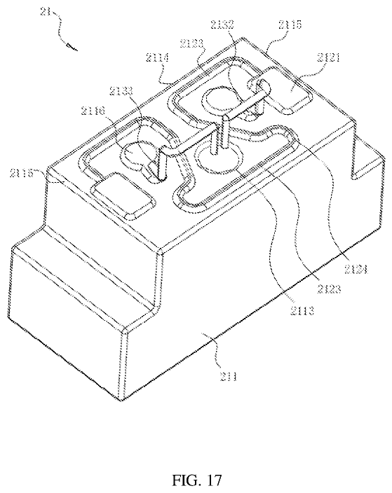

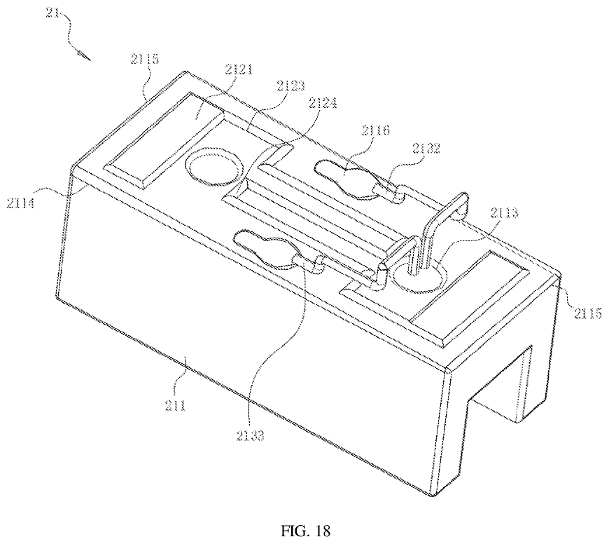

Referring to FIG. 17, the difference between this embodiment and Embodiment 12 is that, the heating bar 2122 includes three first bent sections 2123 parallel to the first edge 2114 and four second bent sections 2124 towards to the second edge 2115. In this embodiment, two of the second bent sections 2124 is in circular arc shape, and the other two of the second bent sections are in fold line shape.

### Embodiment 14

Referring to FIG. 18, the difference between this embodiment and Embodiment 11 is that, two holding grooves 2113 are provided, two holding grooves 2113 are arranged side by side with intervals towards to the direction of the first edge 2114, two holding grooves 2113 are located in the central axis of the ceramic atomizing core 211 parallel to the first edge 2114, and the connection contacts 2116 are located in two side of the central axis of the ceramic atomizing core 211 parallel to the first edge 2114 and in symmetrical distribution. The temperature sensing element 213 can be located in anyone of the two holding grooves 2113, two holding grooves 2113 expand the installation applicability of the temperature sensing element 213 as the location of the temperature sensing element 213 can be adjusted according to the installation location of other elements in the electronic cigarette, and the temperature detection function and effect of the heating wire 212 are not affected.

In this embodiment, the heating bar 2122 includes two first bent sections 2123 towards to the first edge 2114 and two second bent sections 2124 towards to the second edge 2115.

### Embodiment 15

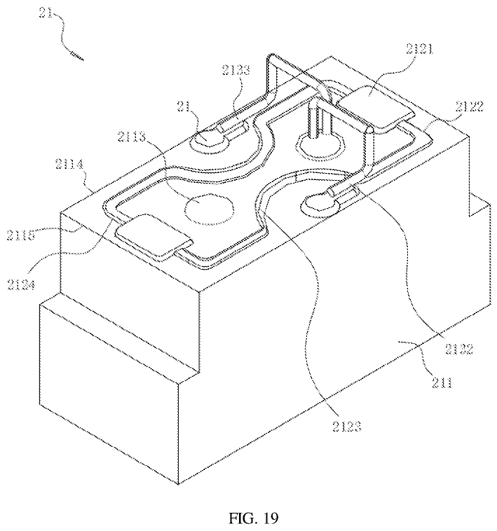

Referring to FIG. 19, the difference between this embodiment and Embodiment 15 is that, the cross section of the ceramic atomizing core 211 is of “8” shape. Two heating wires 212 are provided in this embodiment, two heating wires 212 share two conductive contact 2121. The heating bar 2122 of two heating wires 212 includes two first bent sections 2123 towards to first edge 2114, the first bent sections 2123 are in circular arc shape. The heating bar 2122 further includes two second bent sections 2124 towards to the second edge 2115.

### Embodiment 16

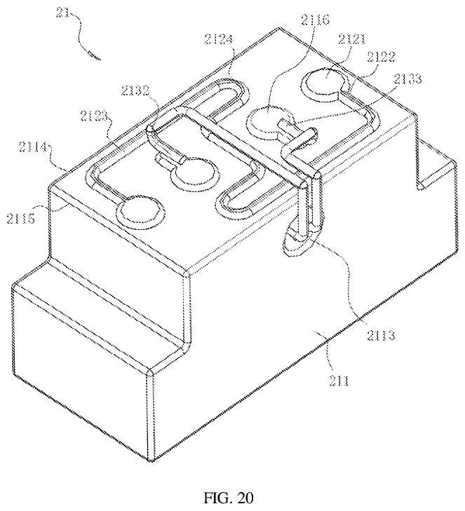

Referring to FIG. 20, the difference between this embodiment and Embodiment 12 is that, the cross section of the ceramic atomizing core 211 is of “8” shape. The heating bar 2122 includes two first bent sections 2123 parallel to the first edge 2114 and two second bent sections 2124 towards to the second edge 2115. The conductive contact 2121 is in disc shape.

### Embodiment 17

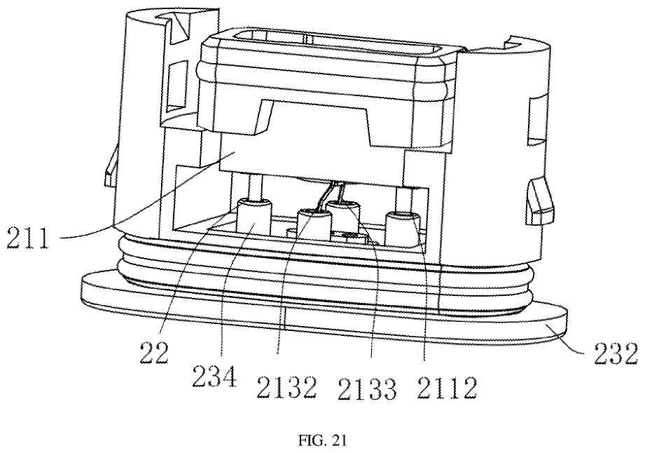

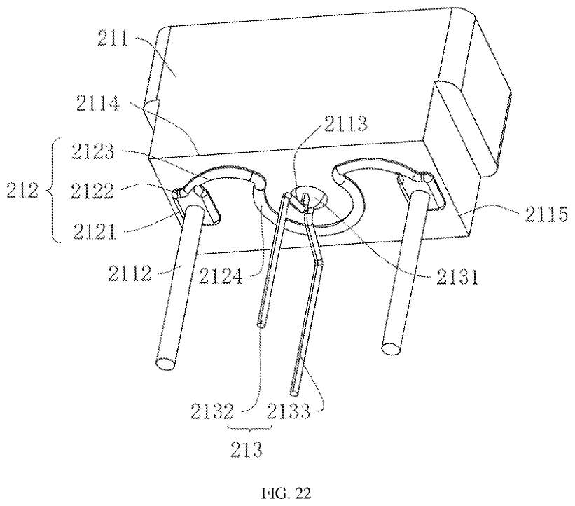

Referring to FIG. 21 and FIG. 22, the difference between this embodiment and Embodiment 1 is that, the casing is provided with a limit tube 234, the limit tube 234 is mounted on the bottom cover 232 and fixed with the bottom cover 232. Four limit tubes 234 are provided, four electrical pins 22 are provided, and two conductive pins 2112 are provided. Four electrical pins 22 are in insertion connection with the limit tube 234, in which two of the electrical pins 22 are located in two ends of the major axis of the bottom cover 232, and other two of the electrical pins 22 are located in two ends of the minor axis of the bottom cover 232, two conductive pins 2112 are located in the central axis of the ceramic atomizing core 211 along length direction, and two conductive pins 2112 are one-to-one corresponding to electrical pins 22 located in two ends of the major axis of the bottom cover 232.

When the bottom cover 232 covers, the ends of two conductive pins 2112 away from the ceramic atomizing core 211 are separately plugged in two of the limit tubes 234, and the conductive pins 2112 are electrically connected to the power supply. The positive pin 2132 and negative pin 2133 are separately plugged in other two of the limit tube 234, the positive pin 2132 and negative pin 2133 are electrically connected to the electrical pin 22 in the limit tube 234. In embodiment of present application, the positive pin 2132 and negative pin 2133 have some elasticity. When positive pin 2132 and negative pin 2133 are located in limit tube 234 as well as contact and press the electrical pin 22, the positive pin 2132 and negative pin 2133 are in a pressed state, which makes the positive pin 2132 and negative pin 2133 have a spring force towards to the bottom cover 232, so that the positive pin 2132 and the negative pin 2133 tightly abuts against the electrical pin 22.

The heating bar 2122 includes two first bent sections towards to the first edge 2114 and a second bent section 2124 towards to the second edge 2115. The first bent section and the second bent section 2124 are in arc shape.

The above are the preferred embodiments of the present application, and do not limit the protection scope of the present application. The same reference mark is used to illustrate the same component herein. It should be appreciated that, the word “upper” and “below” in above description represents the direction in the figures, the word “inner” and “outer” separately represents the direction towards to or away from the geometric center of specific component. Therefore: all equivalent variations made according to the structure, shape, and principle of present application, should be covered in the protection scope of present application.

What is claimed is:

1. An electronic cigarette, comprising a cigarette stem and a cartridge, wherein a battery and a printed circuit board (PCB) are provided in the cigarette stem, an atomizer configured for atomizing e-liquid is provided in the cartridge, the atomizer comprises a ceramic atomizing core, a heating wire configured for heating the e-liquid and a temperature sensing element configured for detecting a temperature of the heating wire, the heating wire and the temperature sensing element are provided on the ceramic atomizing core, the heating wire is electrically connected to the battery, and the temperature sensing element is electrically connected to the PCB.

2. The electronic cigarette according to claim 1, wherein the cartridge is provided with a plurality of electrical pins configured to connect to the PCB, the plurality of electrical pins are arranged at intervals, two ends of the heating wire are separately provided with a conductive contact, and the conductive contacts provided on the two ends of the heating wire are fixed on the ceramic atomizing core and separately electrically connected to two of the plurality of electrical pins.

3. The electronic cigarette according to claim 2, wherein the ceramic atomizing core is provided with a plurality of conductive pins, the plurality of conductive pins are in one-to-one correspondence to the plurality of electrical pins, and one conductive contact is connected to one electrical pin of the plurality of electrical pins via one conductive pin of the plurality of conductive pins.

4. The electronic cigarette according to claim 3, wherein the temperature sensing element comprises a sensing element body, a positive pin and a negative pin, the ceramic atomizing core is provided with a holding groove configured to contain the sensing element body, the sensing element body is in insertion connection with the holding groove, and the positive pin and the negative pin are separately electrically connected to two of the plurality of conductive pins.

5. The electronic cigarette according to claim 4, wherein the cartridge further comprises a casing, two limit tubes are provided in the casing, individual electrical pins of the plurality of electrical pins are separately positioned in the two limit tubes, ends of the positive pin and the negative pin away from the sensing element body are separately positioned in the two limit tubes and abut against and electrically connect to the plurality of electrical pins.

6. The electronic cigarette according to claim 4, wherein three conductive pins of the plurality of conductive pins are arranged side by side at regular intervals, and the holding groove is positioned in a sidewall of the ceramic atomizing core.

7. The electronic cigarette according to claim 4, wherein four conductive pins of the plurality of conductive pins are arranged side by side at regular intervals, the holding groove is positioned in a sidewall of the ceramic atomizing core, and the positive pin and the negative pin are separately electrically connected to two middle conductive pins of the four conductive pins.

8. The electronic cigarette according to claim 4, wherein the holding groove and the plurality of conductive pins are located in a same end face, four conductive pins of the plurality of conductive pins are staggered with each other at regular intervals, and the positive pin and the negative pin are separately electrically connected to two middle conductive pins of the four conductive pins.

9. The electronic cigarette according to claim 4, wherein the ceramic atomizing core is further provided with two connection contacts configured for electrical connection with the temperature sensing element, and the positive pin and the negative pin are connected with two connection contacts, respectively.

10. The electronic cigarette according to claim 2, wherein the atomizer further comprises a spring clip configured for fixing the temperature sensing element, the ceramic atomizing core is provided with a clamping part, the spring clip is in snap connection with the clamping part, and the temperature sensing element is mounted on the spring clip and electrically connected to a power supply.
